(19) United States
(12) Patent Application Publication
(10) Pub. No.: US 2022/0161456 A1
(43) Pub. Date: May 26, 2022

(54) SYNERGISTIC WOOD PRESERVATIVE COMPOSITION COMPRISING POLYMERIC BETAINE AND CARBAMATE

(71) Applicant: Troy Corporation, Florham Park, NJ (US)

(72) Inventors: Min Chen, Florham Park, NJ (US); Jake Zachary JACOBS, Florham Park, NJ (US)

(73) Assignee: Troy Corporation, Florham Park, NJ (US)

(21) Appl. No.: 17/667,162

(22) Filed: Feb. 8, 2022

Related U.S. Application Data
(63) Continuation of application No. PCT/US2020/045452, filed on Aug. 7, 2020.
(60) Provisional application No. 63/221,771, filed on Jul. 14, 2021.
(60) Provisional application No. 62/884,738, filed on Aug. 9, 2019.

(51) Int. Cl. B27K 3/50

(52) U.S. Cl. CPC B27K 3/50

(57) ABSTRACT

A synergistic wood preservation composition comprising a polymeric betaine and 3-iodo-2-propynyl butyl carbamate (IPBC). Also, a method of controlling microorganisms that produce mold and/or sapstain on wood or wood products or wood coating solutions by applying to a wood or wood product or wood coating solutions the synergistic wood preservation composition to control the microorganisms.

### CROSS-REFERENCE TO RELATED APPLICATIONS

The present application is a continuation of PCT International Application No. PCT/US2020/045452, filed Aug. 7, 2020, entitled “SYNERGISTIC WOOD PRESERVATIVE COMPOSITION COMPRISING POLYMERIC BETAINE AND CARBAMATE”, which claims priority to U.S. Provisional Patent Application No. 62/884,738, filed Aug. 9, 2019, entitled “SYNERGISTIC WOOD PRESERVATIVE COMPOSITION COMPRISING POLYMERIC BETAINE AND CARBAMATE,” the contents of all of which are incorporated herein by reference in their entireties for all purposes. The present application also claims priority to U.S. Provisional Patent Application No. 63/221,771, filed Jul. 14, 2021, entitled “SYNERGISTIC WOOD PRESERVATIVE COMPOSITION COMPRISING POLYMERIC BETAINE AND CARBAMATE,” the contents of which are incorporated herein by reference in their entireties for all purposes.

### BACKGROUND OF THE INVENTION

### 1. Field of the Invention

The present invention pertains to synergistic compositions suitable for use in the treatment and preservation of wood, wood products, wood coatings, and wood coating solutions. The antimicrobial compositions of this invention include wood preservative compositions comprising a polymeric betaine and an iodopropynyl compound. These combinations are especially useful in protecting wood, wood products, wood coatings, and wood coating solutions from spoilage resulting from the growth of microorganisms, especially microorganisms that produce mold and sapstain.

### 2. Description of the Background

Substrates of all types, when exposed to common environmental conditions, are prone to attack, spoilage, and various kinds of destruction by a variety of species of microorganisms including fungi, yeast, bacteria, algae, and mold. As a result, there has always been a great need for effective and economical means to protect various materials for extended periods of time, from the defacement, deterioration, and destruction caused by such microorganisms. Materials that need protection against such microorganisms include, for example, wood, wood products, wood coatings, and wood coating solutions, which are prone to degradation by the action of objectionable microorganisms. Such degradation may produce, inter alia, deterioration, discoloration, the formation of objectionable odors, and other adverse effects on the substrate.

A great deal of effort has gone into developing a wide variety of materials which, to various degrees, are effective in retarding or preventing the growth of, and accompanying destruction caused by, such microorganisms in a variety of circumstances. Such antimicrobial materials included halogenated compounds, organometallic compounds, quaternary ammonium compounds, phenolics, metallic salts, heterocyclic amines, formaldehyde adducts, organosulfur compounds, and the like.

No single organic antimicrobial compound is able to provide protection against all microorganisms and is suitable for all applications. In addition to such limitations concerning efficacy, other limitations may restrict the usefulness of certain antimicrobials. For example the stability, physical properties, toxicological profile, regulatory considerations, economic considerations or environmental concerns may render a particular ingredient unsuitable for a particular use. There is a need, therefore, to constantly develop new combinations that will offer broad spectrum protection from a variety of needs.

A judicious choice of combinations may provide a way to maximize benefits while at the same time minimize problems. Ideally, a combination wherein the antimicrobial activity is enhanced while the less desirable properties are suppressed or reduced can provide a superior product. The task is to find such combinations that will provide protection against a wide variety of problem microorganisms, will not adversely affect the product to be protected, will maintain its integrity for an extended period of time, and will not have any strong adverse effects on health or the environment.

### SUMMARY OF THE INVENTION

The present invention is directed to certain synergistic preservative compositions comprising a polymeric betaine and an iodopropynyl compound. The present invention is directed to methods for controlling mold and/or sapstain on wood or wood products by application of an effective amount of such compositions to the wood or wood product substrate. The present invention is also directed to a dry film and wet state preservative by application of an effective amount of such compositions to paints and coatings, and wood coating solutions.

### DETAILED DESCRIPTION OF THE INVENTION

It has been found that when iodopropynyl compounds such as 3-iodo-2-propynyl butyl carbamate (IPBC) are combined with polymeric betaines such as didecyl bis(hydroxyethyl) ammonium borate (DPAB), they form wood preservative compositions that are surprisingly more effective against microorganisms that produce mold and/or sapstain on wood or wood products than either single component alone. It has been found that in the combinations of this invention, the polymeric betaines and iodopropynyl compounds complement one another in a way that could not be anticipated. The polymeric betaines and iodopropynl compound show synergistic activity. This unexpected synergistic activity offers a number of advantages in the preservation of wood and wood products.

This invention relates to the synergistic wood preservative composition comprising polymeric betaine, or more precisely didecyl bis(hydroxyethyl) ammonium borate (DPAB), and 3-iodo-2-propynyl butyl carbamate having the properties of providing effective and broad control of microorganisms that produce mold and sapstain. Suitable polymeric betaines are described in, for example, U.S. Pat. No. 5,304,237, the entire contents of which are incorporated herein by reference for all purposes. The structural formula of DPAB is:

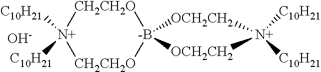

The compositions of the present invention can be prepared as solutions or emulsions by conventional means by using water or organic liquids as a solvent. A preferred form is to combine a water solution of polymeric betaine and an organic solvent solution of IPBC. The process conditions for the preparation of the composition of the invention are at ambient temperature.

The quantity and ratio of polymeric betaine and IPBC will depend upon the specific application. Generally, the wood preservative composition will contain from about 1 to 100 parts by weight polymeric betaine per about 1 to 100 parts by weight IPBC. More preferably, the composition will contain about 1 to 90, 1 to 80, 1 to 70, 1 to 60, 1 to 50, or 1 to 40 parts by weight of polymeric betaine per 1 to 90, 1 to 80, 1 to 70, 1 to 60, 1 to 50, or 1 to 40 parts by weight of IPBC. A preferred weight ratio of polymeric betaine to IPBC is from about 30:1 to about 1:30, more preferably 20:1 to 1:20, even more preferably 10:1 to 1:10. A particularly preferred ratio of polymeric betaine to IPBC is from 5:1 to 10:1 parts by weight, i.e., about 5 to 10 parts by weight polymeric betaine per part by weight IPBC. Other preferred ratios of polymeric betaine to IPBC include 1:1, 2:1 to 1:2, 3:2 to 2:3, 3:1 to 1:3, 4:1 to 1:4, 4:3 to 3:4, 5:1 to 1:5, 5:2 to 2:5, 5:3 to 3:5, 5:4 to 4:5, 6:1 to 1:6, 6:5 to 5:6, 7:1 to 1:7, 7:2 to 2:7, 7:3 to 3:7, 7:4 to 4:7, 7:5 to 5:7, 7:6 to 6:7, 8:1 to 1:8, 8:3 to 3:8, 8:5 to 5:8, 8:7 to 7:8, 9:1 to 1:9, 9:2 to 2:9, 9:4 to 4:9, 9:5 to 5:9, 9:7 to 7:9, 9:8 to 8:9, 10:9 to 9:10, 10:7 to 7:10, 20:19 to 19:20, 20:17 to 17:20, 20:13 to 13:20, 20:11 to 11:20, 20:7 to 7:20, 20:3 to 3:20, and 10:3 to 3:10. Any of the upper limits of these ranges may be combined with the lower limits of the other ranges, and vice-versa, in accordance with other aspects of the invention.

It may be advantageous to supply the preservative composition in concentrated form with about 15, 20, 25, 30, 35, 40, or 45 percent by weight of solvent to about 50, 55, 60, 65, 70, 75, or 80 percent by weight solvent. According to another aspect of the invention the composition may comprise more than 80 percent by weight of solvents, for example from 80 to 99.9, 85 to 99.9, 90 to 99.9, 90.5 to 99.9, 91 to 99.9, 91.5 to 99.9, 92 to 99.9, 92.5 to 99, 93 to 99.9, or 95 to 99.9 percent by weight of solvent. Typical solvents include water and/or organic solvents, including aromatic organic solvents, polar and non-polar organic solvents, and aliphatic organic solvents.

Non-limiting examples of suitable solvents are water, ethanol, ethylene glycol, propanol, polyethylene glycol, dimethylsulfoxide, naptha, 1,2,4, trimethyl benzene, alkyl ethers, 1,3,5 trimethyl benzene, methylethyl benzene, and mixtures thereof. The concentrate is generally diluted about 10 to 200 times to working solution strength by the addition of water (or another solvent). The diluted solution or emulsion can be applied to wood by conventional treating methods such as immersion, brush, spray, flooding, or pressure.

These antimicrobial mixtures provide a high level of activity over a prolonged period, enhancing the strengths of the individual ingredients while minimizing the weaknesses of each. It is this type of complimentary activity that allows one to use less biocide in combination to achieve a desired effect at levels that cannot be achieved with any of the individual ingredients.

The halopropynyl compounds that can be used in accordance with the present invention, for the most part, are well known and can be generally identified by the following structure:

YC═C—CH₂X

wherein Y is halogen, and X can be (1) oxygen that is part of an organic functional group; (2) nitrogen that is part of an organic functional group; (3) sulfur that is part of an organic functional group; or (4) carbon that is part of an organic functional group.

The functional group of which oxygen is a part, is preferably an ether, an ester, or a carbamate group. The functional group of which nitrogen is a part is preferably an amine, an amide, or a carbamate group. The functional group of which sulfur is a part is preferably a thiol, a thiane, a sulfone, or a sulfoxide group. The organic functional group of which carbon is a part is preferably an ester, a carbamate or an alkyl group.

Examples of compounds that may be used as the halopropynyl compound of this invention are especially the active iodopropynyl derivatives some of which are reported in U.S. Pat. Nos. 3,923,870; 4,259,350; 4,592,773; 4,616,004; 4,719,227; and 4,945,109, the contents of all of which are incorporated by reference herein in their entireties for all purposes. These iodopropynyl derivatives include compounds derived from propynyl or iodopropynyl alcohols such as esters, acetals, carbamates and carbonates and further include the iodopropynyl derivatives of pyrimidines, thiazolinones, tetrazoles, triazinones, sulfamides, benzothiazoles, ammonium salts, carboxamides, and ureas. The preferred and most widely used among these compounds is the halopropynyl carbamate, 3-iodo-2-propynyl butyl carbamate. These compounds are included within the useful class of compounds having the generic formula:

[IC≡C—(CH₂)ₘ—O—C(═O)—NH]ₙ—R

wherein R may have one to three linkages corresponding to n and is selected from the group consisting of hydrogen, substituted and unsubstituted alkyl groups having from 1 to 20 carbon atoms, substituted and unsubstituted aryl, alkylaryl, and aralkyl of from 6 to 20 carbon atoms or cycloalkyl and cycloalkenyl groups of from 3 to 10 carbon atoms, and m and n are independently integers from 1 to 3, i.e., they are not necessarily the same.

Particularly preferred are formulations of such halopropynyl carbamates where m is 1 and n is 1 and which have the following formula:

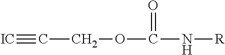

Suitable R substituents include alkyls such as methyl, ethyl, propyl, n-butyl, t-butyl, pentyl, hexyl, heptyl, octyl, nonyl, decyl, dodecyl, and octadecyl; cycloalkyls such as cyclohexyl; aryls, alkaryls and aralkyls such as phenyl, benzyl, tolyl, and cumyl; halogenated alkyls and aryls, such as chlorobutyl and chlorophenyl; and alkoxy aryls such as ethoxyphenyl and the like.

Especially preferred are such iodopropynyl carbamates as 3-iodo-2-propynyl propyl carbamate, 3-iodo-2-propynyl butyl carbamate, 3-iodo-2-propynyl hexyl carbamate, 3-iodo-2-propynyl cyclohexyl carbamate, 3-iodo-2-propynyl phenyl carbamate, and mixtures thereof.

Compositions of the present invention will generally be formulated by mixing or dispersing the active ingredients in a selected proportion with a liquid vehicle for dissolving or suspending the active components. The vehicle may contain a diluent, an emulsifier, and a wetting-agent. The compositions of this invention may be provided as liquid mixtures such as dispersions, emulsions, microemulsions, or in any other suitable product form that is desirable or most useful.

When preparing formulations of the present invention for specific applications, the composition also will likely be provided with adjuvants conventionally employed in compositions intended for such applications such as organic binding agents, additional fungicides, auxiliary solvents, processing additives, fixatives, plasticizers, UV-stabilizers or stability enhancers, water soluble or water insoluble dyes, color pigments, siccatives, corrosion inhibitors, anti-settlement agents, anti-skinning agents and the like.

Applications

According to the present invention, substrates, especially wood and wood coating solutions, are protected from contamination by microorganisms simply by treating said substrate with a composition of the present invention. Such treating may involve mixing the composition with the substrate, coating or otherwise contacting the substrate with the composition and the like. Expected uses of the biocidal compositions include the protection of wood, wood products, fresh sawn timber, wood coating solutions, and the like.

Non-limiting examples of suitable substrates are wood, wood products intended for indoor and outdoor structural and non-structural applications such as, sheetrock, particle board, engineered lumber, plywood, glue-laminated wood beams, laminated veneer lumber, oriented strand board, AC plywood, CDX plywood, I-joists, structured composite lumber, rim board, and the like. Any species of wood is suitable. The inhibitor may be applied under or over a coating (e.g., paint or stain) on the wood or wood product. The inhibitor may be included in a coating intended for us on such wood or wood products.

According to a preferred method, an inhibited substrate may be prepared by treating a bare or coated substrate with the synergistic composition comprising a polymeric betaine and 3-iodo-2-propynyl butyl carbamate (IPBC), and allowing a solvent or carrier in the composition to evaporate. Optionally, the evaporation step may be carried out with the application of heat, or by forced convection or a combination.

Microorganisms whose growth may be inhibited are for example Trichoderma pseudokoningii (ATCC #26801), Aureobasidium pullulans (ATCC #9348), of Aspergillus niger (ATCC #6275), Penicillium funiculosum (ATCC #11797), and mixtures thereof.

The following examples are presented to illustrate and explain the invention. Unless otherwise indicated, all references to parts and percentages are based on weight.

### Example 1

To show the efficacy and synergy of the composition of the invention on wood-deteriorating microorganisms, the following solutions were prepared:

(A) 0.17 g of 60% DPAB aqueous solution (ProTek® PBT or Polymeric Betaine EP or Polymeric Betaine Technical Grade Active Ingredient Wood Preservative, Troy Chemical Corporation, Newark, N.J.) was diluted in 9.83 g ethanol by stirring to form a concentrate containing 1% DPAB.

(B) 0.25 g of 40% IPBC solvent solution (Polyphase® AF-1, Troy Chemical Corporation, Newark, N.J.) was diluted in 9.75 g ethanol by stirring to form a concentrate containing 1% IPBC.

(C) 21.04 g of 60% DPAB aqueous solution (ProTek® PBT or Polymeric Betaine EP or Polymeric Betaine Technical Grade Active Ingredient Wood Preservative, Troy Chemical Corporation, Newark, N.J.), 6.25 g of 40% IPBC solvent solution (Polyphase AF-1, Troy Chemical Corporation, Newark, N.J.) and 22.74 g of ethanol were mixed and stirred. The resulting concentrate contained 25% polymeric betaine and 5% IPBC. The weight ratio of polymeric betaine to IPBC was 5:1. 0.33 g of this IPBC/polymeric betaine concentrate was diluted in 9.67 g of ethanol to form a use-dilution containing about 0.83% DPAB and 0.17% IPBC.

Solutions prepared as described above were tested in 96-well plates for their ability to inhibit fungal growth. The solutions were tested according to the EUCAST methodology as described in Rodriguez-Tudela et al. 2006 “Antifungal susceptibility testing in Aspergillus spp. according to EUCAST methodology,” the contents of which are incorporated by reference herein. The solutions were checked for inhibition against fungal organisms Aspergillus niger (ATCC #6275), Aureobasidium pullulans (ATCC #9348), Penicillium funiculosum (ATCC #11797) and Trichoderma pseudokoningii (ATCC #26801). This method is described below:

(1) Prepared preservative test wells by adding 2 microliters of each 1% preservative solution formulation to 198 microliters of 2xRPMI-MOPS-2% Glucose in each column “1” in duplicate.

(2) Added 100 microliters of 2xRPMI-MOPS-2% Glucose to the remaining columns.

(3) Performed 2-fold dilutions down the columns to column “12”.

(4) Prepared suspension of microorganisms from a 3-5 day old PDA slants by flooding slant with 1 mL deionized water and 0.1% Tween-20.

(5) Suspension strength was determined via hemocytometer then adjusted to 1×10⁶ spores/mL with sterile deionized water.

(6) Added 100 microliters of the microorganism suspension to all wells except for sterility (−) controls containing test media. The water used to prepare the fungal suspensions was added to sterility (−) control wells.

(7) The inoculated 96-well plates were incubated for 3 days at 35° C.

(8) After incubation, fungal growth was evaluated by visual growth in test wells. Minimum inhibitory concentration (MIC) is recorded in ppm and defined as the lowest concentration of fungicide that produces no visual changes in turbidity in the test wells. (+) in each block indicates growth and (−) indicates no growth, i.e., the inhibitor was effective.

(9) The experiment is only considered valid if growth is observed in the positive (+) control wells and no growth is observed in the negative control wells.

The effectiveness on all four examined microorganisms is presented in Tables 1 to 4.

TABLE 1
The growth of Aspergillus niger (ATCC# 6275) in 96-well plates containing selected concentrations
of DPAB, IPBC and their mixture. The values stated wells 1 through 12 are in ppm active.

| ID | Test solutions a.i. | 1 | 2 | 3 | 4 | 5 | 6 | 7 | 8 | 9 | 10 | 11 | 12 |
|---|---|---|---|---|---|---|---|---|---|---|---|---|---|
| A | 1% IPBC | 50.0 | 25.0 | 12.5 | 6.25 | 3.13 | 1.56 | 0.78 | 0.39 | 0.20 | 0.10 | 0.05 | 0.02 |
| | | − | − | − | − | − | − | − | + | + | + | + | + |
| B | 1% IPBC | 50.0 | 25.0 | 12.5 | 6.25 | 3.13 | 1.56 | 0.78 | 0.39 | 0.20 | 0.10 | 0.05 | 0.02 |
| | | − | − | − | − | − | − | − | + | + | + | + | + |
| C | 1% DPAB | 50.0 | 25.0 | 12.5 | 6.25 | 3.13 | 1.56 | 0.78 | 0.39 | 0.20 | 0.10 | 0.05 | 0.02 |
| | | − | − | − | + | + | + | + | + | + | + | + | + |
| D | 1% DPAB | 50.0 | 25.0 | 12.5 | 6.25 | 3.13 | 1.56 | 0.78 | 0.39 | 0.20 | 0.10 | 0.05 | 0.02 |
| | | − | − | − | + | + | + | + | + | + | + | + | + |
| E | 1% (IPBC + DPAB) | 50.0 | 25.0 | 12.5 | 6.25 | 3.13 | 1.56 | 0.78 | 0.39 | 0.20 | 0.10 | 0.05 | 0.02 |
| | | − | − | − | − | − | − | + | + | + | + | + | + |
| F | 1% (IPBC + DPAB) | 50.0 | 25.0 | 12.5 | 6.25 | 3.13 | 1.56 | 0.78 | 0.39 | 0.20 | 0.10 | 0.05 | 0.02 |
| | | − | − | − | − | − | − | + | + | + | + | + | + |
| G | Controls | + | + | + | + | + | + | − | − | − | − | − | − |

TABLE 2
The growth of Aureobasidium pullulans (ATCC# 9348) in 96-well plates
containing selected concentrations of DPAB, IPBC and their mixture. The values stated
wells 1 through 12 are in ppm active.

| ID | Test solutions a.i. | 1 | 2 | 3 | 4 | 5 | 6 | 7 | 8 | 9 | 10 | 11 | 12 |
|---|---|---|---|---|---|---|---|---|---|---|---|---|---|
| A | 1% IPBC | 50.00 | 25.00 | 12.50 | 6.25 | 3.13 | 1.56 | 0.78 | 0.39 | 0.20 | 0.10 | 0.05 | 0.02 |
| | | − | − | + | + | + | + | + | + | + | + | + | + |
| B | 1% IPBC | 50.00 | 25.00 | 12.50 | 6.25 | 3.13 | 1.56 | 0.78 | 0.39 | 0.20 | 0.10 | 0.05 | 0.02 |
| | | − | − | + | + | + | + | + | + | + | + | + | + |
| C | 1% DPAB | 50.00 | 25.00 | 12.50 | 6.25 | 3.13 | 1.56 | 0.78 | 0.39 | 0.20 | 0.10 | 0.05 | 0.02 |
| | | − | − | − | + | + | + | + | + | + | + | + | + |
| D | 1% DPAB | 50.00 | 25.00 | 12.50 | 6.25 | 3.13 | 1.56 | 0.78 | 0.39 | 0.20 | 0.10 | 0.05 | 0.02 |
| | | − | − | − | + | + | + | + | + | + | + | + | + |
| E | 1% (IPBC + DPAB) | 50.00 | 25.00 | 12.50 | 6.25 | 3.13 | 1.56 | 0.78 | 0.39 | 0.20 | 0.10 | 0.05 | 0.02 |
| | | − | − | − | − | + | + | + | + | + | + | + | + |
| F | 1% (IPBC + DPAB) | 50.00 | 25.00 | 12.50 | 6.25 | 3.13 | 1.56 | 0.78 | 0.39 | 0.20 | 0.10 | 0.05 | 0.02 |
| | | − | − | − | − | + | + | + | + | + | + | + | + |
| G | Controls | + | + | + | + | + | + | − | − | − | − | − | − |

TABLE 3
The growth of Penicillium funiculosum (ATCC# 11797) in 96-well plates
containing selected concentrations of DPAB, IPBC and their mixture.

| ID | Test solutions a.i. | 1 | 2 | 3 | 4 | 5 | 6 | 7 | 8 | 9 | 10 | 11 | 12 |
|---|---|---|---|---|---|---|---|---|---|---|---|---|---|
| A | 1% IPBC | 50.00 | 25.00 | 12.50 | 6.25 | 3.13 | 1.56 | 0.78 | 0.39 | 0.20 | 0.10 | 0.05 | 0.02 |
| | | − | − | − | − | − | − | − | + | + | + | + | + |
| B | 1% IPBC | 50.00 | 25.00 | 12.50 | 6.25 | 3.13 | 1.56 | 0.78 | 0.39 | 0.20 | 0.10 | 0.05 | 0.02 |
| | | − | − | − | − | − | − | − | + | + | ++ | | + |
| C | 1% DPAB | 50.00 | 25.00 | 12.50 | 6.25 | 3.13 | 1.56 | 0.78 | 0.39 | 0.20 | 0.10 | 0.05 | 0.02 |
| | | − | − | − | − | + | + | + | + | + | + | + | + |
| D | 1% DPAB | 50.00 | 25.00 | 12.50 | 6.25 | 3.13 | 1.56 | 0.78 | 0.39 | 0.20 | 0.10 | 0.05 | 0.02 |
| | | − | − | − | − | + | + | + | + | + | + | + | + |
| E | 1% (IPBC + DPAB) | 50.00 | 25.00 | 12.50 | 6.25 | 3.13 | 1.56 | 0.78 | 0.39 | 0.20 | 0.10 | 0.05 | 0.02 |
| | | − | − | − | − | − | + | + | + | + | + | + | + |
| F | 1% (IPBC + DPAB) | 50.00 | 25.00 | 12.50 | 6.25 | 3.13 | 1.56 | 0.78 | 0.39 | 0.20 | 0.10 | 0.05 | 0.02 |
| | | − | − | − | − | − | + | + | + | + | + | + | + |
| G | Controls | + | + | + | + | + | + | − | − | − | − | − | − |

TABLE 4
The growth of Trichoderma pseudokoningii (ATCC# 26801) in 96-well plates
containing selected concentrations of DPAB, IPBC and their mixture. The values stated
wells 1 through 12 are in ppm active.

| ID | Test solutions a.i. | 1 | 2 | 3 | 4 | 5 | 6 | 7 | 8 | 9 | 10 | 11 | 12 |
|---|---|---|---|---|---|---|---|---|---|---|---|---|---|
| A | 1% IPBC | 50.00 | 25.00 | 12.50 | 6.25 | 3.13 | 1.56 | 0.78 | 0.39 | 0.20 | 0.10 | 0.05 | 0.02 |
| | | − | − | − | − | + | + | + | + | + | + | + | + |
| B | 1% IPBC | 50.00 | 25.00 | 12.50 | 6.25 | 3.13 | 1.56 | 0.78 | 0.39 | 0.20 | 0.10 | 0.05 | 0.02 |
| | | − | − | − | − | + | + | + | | + | + | + | + |
| C | 1% DPAB | 50.00 | 25.00 | 12.50 | 6.25 | 3.13 | 1.56 | 0.78 | 0.39 | 0.20 | 0.10 | 0.05 | 0.02 |
| | | − | − | + | + | + | + | + | + | + | + | + | + |
| D | 1% DPAB | 50.00 | 25.00 | 12.50 | 6.25 | 3.13 | 1.56 | 0.78 | 0.39 | 0.20 | 0.10 | 0.05 | 0.02 |
| | | − | − | + | + | + | + | + | + | + | + | + | + |
| E | 1% (IPBC + DPAB) | 50.00 | 25.00 | 12.50 | 6.25 | 3.13 | 1.56 | 0.78 | 0.39 | 0.20 | 0.10 | 0.05 | 0.02 |
| | | − | − | − | − | + | + | + | + | + | + | + | + |
| F | 1% (IPBC + DPAB) | 50.00 | 25.00 | 12.50 | 6.25 | 3.13 | 1.56 | 0.78 | 0.39 | 0.20 | 0.10 | 0.05 | 0.02 |
| G | Controls | + | + | + | + | + | + | − | − | − | − | − | − |

In order to show more directly the possible synergy in the invention, the results are presented by applying the Synergy Index (S.I.). Minimal inhibitory concentration of the composition of this invention (mixture of DPAB and IPBC) are analyzed using the following equation:

(MCA′/MCA)+(MCB′/MCB)=SI

Wherein:

MCA=Concentration of compound A in parts per million, acting alone, which prevents fungal growth at the reference point

MCA′=Concentration of compound A in parts per million, in the mixture, which prevents fungal growth at the reference point

MCB=Concentration of compound B in parts per million, acting alone, which prevents fungal growth at the reference point

MCB′=Concentration of compound B in parts per million, in the mixture, which prevents fungal growth at the reference point

When SI is greater than 2, antagonism is indicated. When SI is less than 0.5, synergy is demonstrated. When SI is between 0.5 and 2, the action of biocides is additive.

Table 5 represents an anti-fungal activity of IPBC, DPAB, and their mixture at 1:5, respectively. The simultaneous activity of the two actives is expressed as Synergy Index.

TABLE 5
Synergistic anti-fungal activity of IPBC and DPAB

| | | MIC (ppm) | | | |
|---|---|---|---|---|---|
| | | | | IPBC/ | |
| | | | | DPAB | |
| | | | | (Ratio of | Synergy |
| Microorganisms | ATCC | IPBC | DPAB | 1:5) | Index |
| Aspergillus niger | 6275 | 0.78 | 12.50 | 3.13 | 0.88 |
| Aureobasidium | 9348 | 25.00 | 12.5 | 6.25 | 0.46 |
| pullulans | | | | | |
| Penicillium | 11797 | 0.78 | 6.25 | 3.13 | 1.08 |
| funiculosum | | | | | |
| Trichoderma | 26801 | 6.25 | 25.00 | 6.25 | 0.38 |
| pseudokoningii | | | | | |

Table 5 above demonstrates that a 1:5 ratio of IPBC/DPAB acts synergistically to inhibit the growth of Aureobasidium pullulans at 6.25 ppm or more and also synergistically inhibits the growth of Trichoderma pseudokoningii at 6.25 ppm or more.

### Example 2

To show the efficacy of the composition of the invention on wood-deteriorating microorganisms that cause mold and sapstain extended into dip-treatment applications on wood, the following solutions were prepared:

(A) 12.00 g of 40% IPBC aqueous solution (Polyphase® PW40LV, Troy Chemical Corporation, Newark, N.J.) was diluted with 988.00 g of water by stirring to form a use dilution containing 4800 ppm of IPBC.

(B) 700.00 g of solution prepared in step (A) was diluted with 700.00 g of water by stirring to form a use-dilution containing about 2400 ppm IPBC.

(C) 8.90 g of 60% DPAB aqueous solution (ProTek® PBT or Polymeric Betaine EP or Polymeric Betaine Technical Grade Active Ingredient Wood Preservative, Troy Chemical Corporation, Newark, N.J.) was diluted with 1104.80 g of water by stirring to form a use dilution containing 4800 ppm DPAB.

(D) 700.0 g of solution prepared in step (C) was diluted with 700.0 g of water by stirring to form a use-dilution containing about 2400 ppm IPBC.

(E) 21.04 g of 60% DPAB aqueous solution (ProTek® PBT or Polymeric Betaine EP or Polymeric Betaine Technical Grade Active Ingredient Wood Preservative, Troy Chemical Corporation, Newark, N.J.), 6.25 g of 40% IPBC in dimethylsulfoxide, naptha, 1,2,4, trimethyl benzene, alkyl ethers, 1,3,5 trimethyl benzene, methylethyl benzene solvent solution (Polyphase® AF-1, Troy Chemical Corporation, Newark, N.J.), and 22.74 g of ethanol were mixed and stirred. The resulting concentrate contained 25% DPAB and 5% IPBC. The weight ratio of polymeric betaine to IPBC was 5:1. 19.20 g of this IPBC/Polymeric Betaine concentrate was diluted with 1180.80 g of water by stirring to form a use-dilution containing about 4000 ppm DPAB and 800 ppm IPBC.

(F) 700.00 g of solution prepared in step (E) was diluted with 700.00 g of water by stirring to form a use-dilution containing about 2000 ppm DPAB and 400 ppm IPBC.

Radiata pine lumber was machined to specimens with size of 7 mm by 20 mm in cross section and 70 mm long. Solutions prepared as described above were used to treat the machined Radiata pine specimens. The treatment was carried out in a 600 mL beaker. Two unused test pieces were placed on the bottom of the beaker, and the specimens, four in a layer, were placed on the previous layers until all the treatment replicates were included. The specimens were held down with a finger bearing down on a watch glass and submerged in treating solution for 15 seconds. After 15 seconds, the beaker was drained but with specimens still held down, and then was tightly covered with a piece of plastic sheet to prevent drying and was stored overnight. Similarly, untreated control specimens were treated with water.

One day after treatment, duplicate wood specimens from the same treatment group were tested according to ASTM D4445-10 methodology. The wood specimens were checked for inhibition against sapstain fungi and molds Trichoderma pseudokoningii (ATCC #26801), Aureobasidium pullulans (ATCC #9348), and a mixture of Aspergillus niger (ATCC #6275) and Penicillium funiculosum (ATCC #11797). This method is described below:

(1) Placed duplicate wood specimens on top of polyester mesh and laid on a stack of four (4) filter paper squares (approximately 2 inches by 2.5 inches) presoaked in 5 mL sterile DI water.

(2) Prepared fungal mixture from freshly grown slants of each test organism.

(3) Added 2 mL of DI water and 0.1% Tween 20 to the slant and inverted to mix.

(4) Poured the concentrate into a total volume of 16 mL.

(5) Enumerated the stock via hemocytometer and adjusted to 106 spores/ml with additional DI water.

(6) Inoculated wood specimens via applying 0.25 mL of one of the three separate fungal suspensions to the top of the wood and distributing evenly on the surface with an L-spreader.

(7) Placed inoculated wood specimens in a humidity chamber for one month at 95% or larger relative humidity and 28° C.

(8) Rated wood specimens with a rating from “0” (No Growth) to “5” (Complete Growth).

The effectiveness of sapstain and mildew resistance on all three examined organisms is presented in Table 6. In order to show more directly the possible synergy in the invention, the results are presented by applying the Synergy Index (S.I.), which is analyzed using the following equation:

(FGA′/FGA)+(FGB′/FGB)=SI

Wherein:

FGA=Cumulative fungal growth scores of all three examined organisms of compound A, acting alone

FGA′=Cumulative fungal growth scores of all three examined organisms of compound A, in the mixture

FGB=Cumulative fungal growth scores of all three examined organisms of compound A, acting alone

FGB′=Cumulative fungal growth scores of all three examined organisms of compound A, in the mixture

When SI is greater than 1, antagonism is indicated. When SI is less than 1, synergy is demonstrated. When SI equals to 1, the action of biocides is additive.

TABLE 6
ASTM D4445-10 test result averages. [Cumulative fungal
growth scores (0 to 5) from each set of fungi averaged over all eight (8)
replicates are presented, as well as a fractional score normalized to the
water-only control.]

| | | | | | % of | |
|---|---|---|---|---|---|---|
| | Average Scoring | | | | Water- | |
| Treatment | | | A.n. + | Σ Fungal | Only | Synergy |
| Solution | T.p. | A.p. | P.f. | Growth | Control | Index |
| DPAB-2400 ppm | 2.5 | 3.3 | 5.0 | 10.8 | 77.5 | — |
| DPAB-4800 ppm | 2.0 | 0.8 | 4.9 | 7.6 | 55.0 | — |
| IPBC-2400 ppm | 2.6 | 0.0 | 0.0 | 2.6 | 18.9 | — |
| IPBC-4800 ppm | 2.8 | 0.0 | 0.0 | 2.8 | 19.8 | — |
| IPBC + DPAB- | 2.5 | 0.0 | 0.0 | 2.5 | 18.0 | 0.35 |
| 2400 ppm (1:5) | | | | | | |
| IPBC + DPAB- | 2.1 | 0.1 | 0.0 | 2.3 | 16.2 | 0.38 |
| 4800 ppm (1:5) | | | | | | |
| Water | 3.9 | 5.0 | 5.0 | 13.9 | — | — |

Table 6 above demonstrates that at levels of greater than 2400 ppm, a ratio of 1:5 IPBC:DPAP is synergistically effective against sapstain fungi and molds Trichoderma pseudokoningii (ATCC #26801), Aureobasidium pullulans (ATCC #9348), and a mixture of Aspergillus niger (ATCC #6275) and Penicillium funiculosum (ATCC #11797) growth on wood.

### Example 3

To show the efficacy of the composition of the invention with different IPBC-to-DPAB ratios on wood deteriorating microorganisms extending into dip-treatment applications on wood, the following solutions were prepared:

(A) 6.12 g of 40% IPBC aqueous solution (Polyphase® PW40, Troy Chemical Corporation, Newark, N.J.), 0.21 g of 60% DPAB (ProTek® PBT or Polymeric Betaine EP or Polymeric Betaine Technical Grade Active Ingredient Wood Preservative, Troy Chemical Corporation, Newark, N.J.), and 993.77 g of water were mixed and stirred to form a use-dilution containing 2286 ppm IPBC and 114 ppm DPAB. The weight ratio of IPBC to polymeric betaine was 20:1.

(B) 5.85 g of 40% IPBC aqueous solution (Polyphase® PW40, Troy Chemical Corporation, Newark, N.J.), 0.39 g of 60% DPAB (ProTek® PBT or Polymeric Betaine EP or Polymeric Betaine Technical Grade Active Ingredient Wood Preservative, Troy Chemical Corporation, Newark, N.J.), and 993.83 g of water were mixed and stirred to form a use-dilution containing 2182 ppm IPBC and 218 ppm DPAB. The weight ratio of IPBC to polymeric betaine was 10:1.

(C) 5.35 g of 40% IPBC aqueous solution (Polyphase® PW40, Troy Chemical Corporation, Newark, N.J.), 0.78 g of 60% DPAB (ProTek® PBT or Polymeric Betaine EP or Polymeric Betaine Technical Grade Active Ingredient Wood Preservative, Troy Chemical Corporation, Newark, N.J.), and 993.99 g of water were mixed and stirred to form a use-dilution containing 2000 ppm IPBC and 400 ppm DPAB. The weight ratio of IPBC to polymeric betaine was 5:1.

(D) 1.10 g of 40% IPBC aqueous solution (Polyphase® PW40, Troy Chemical Corporation, Newark, N.J.), 3.71 g of 60% DPAB (ProTek® PBT or Polymeric Betaine EP or Polymeric Betaine Technical Grade Active Ingredient Wood Preservative, Troy Chemical Corporation, Newark, N.J.), and 995.38 g of water were mixed and stirred to form a use-dilution containing 400 ppm IPBC and 2000 ppm DPAB. The weight ratio of IPBC to polymeric betaine was 1:5.

(E) 0.59 g of 40% IPBC aqueous solution (Polyphase® PW40, Troy Chemical Corporation, Newark, N.J.), 4.15 g of 60% DPAB (ProTek® PBT or Polymeric Betaine EP or Polymeric Betaine Technical Grade Active Ingredient Wood Preservative, Troy Chemical Corporation, Newark, N.J.), and 995.37 g of water were mixed and stirred to form a use-dilution containing 218 ppm IPBC and 2182 ppm DPAB. The weight ratio of IPBC to polymeric betaine was 1:10.

(F) 0.31 g of 40% IPBC aqueous solution (Polyphase® PW40, Troy Chemical Corporation, Newark, N.J.), 4.27 g of 60% DPAB (ProTek® PBT or Polymeric Betaine EP or Polymeric Betaine Technical Grade Active Ingredient Wood Preservative, Troy Chemical Corporation, Newark, N.J.), and 995.75 g of water were mixed and stirred to form a use-dilution containing 114 ppm IPBC and 2286 ppm DPAB. The weight ratio of IPBC to polymeric betaine was 1:20.

(G) 8.02 g of 40% IPBC aqueous solution (Polyphase® PW40, Troy Chemical Corporation, Newark, N.J.) were diluted in 991.98 g of water by stirring to form a use-dilution containing 2400 ppm IPBC.

(H) 4.45 g of 60% DPAB (ProTek® PBT or Polymeric Betaine EP or Polymeric Betaine Technical Grade Active Ingredient Wood Preservative, Troy Chemical Corporation, Newark, N.J.) were diluted with 993.77 g of water by stirring to form a use-dilution containing 2400 ppm DPAB.

Radiata pine lumber was machined to specimens with size of 7 mm by 20 mm in cross section and 70 mm long. Solutions prepared as described above were used to treat machined Radiata pine specimens. The treatment was carried out in a 600 mL beaker. Two unused test pieces were placed on the bottom of the beaker, and the specimens, four in a layer, were placed on the previous layers until all the treatment replicates were included. The specimens were held down with a finger bearing down on a watch glass and submerged in treating solution for 15 seconds. After 15 seconds, the beaker was drained but with specimens still held down, and then was tightly covered with a piece of plastic sheet to prevent drying and was stored overnight. Similarly, untreated control specimens were treated with water.

One day after treatment, duplicate wood specimens from the same treatment group were tested according to ASTM D4445-10(2019) methodology. The wood specimens were checked for inhibition against sapstain fungi and molds Trichoderma pseudokoningii (ATCC #26801), Aureobasidium pullulans (ATCC #9348), and a mixture of Aspergillus niger (ATCC #6275) and Penicillium funiculosum (ATCC #11797). This method is briefly described below:
(1) Placed duplicate wood specimens on top of polyester mesh and laid on a stack of four (4) filter paper squares (approximately 2 inches by 2.5 inches) presoaked in 5 mL sterile DI water.
(2) Prepared fungal mixture from freshly grown slants of each test organism.
(3) Added 2 mL of DI water and 0.1% Tween 20 to the slant and inverted to mix.
(4) Poured the concentrate into a total volume of 16 mL.
(5) Enumerated the stock via hemocytometer and adjusted to 10⁶ spores/ml with additional DI water.
(6) Inoculated wood specimens via applying 0.25 mL of one of the three separate fungal suspensions to the top of the wood and distributing evenly on the surface with an L-spreader.
(7) Placed inoculated wood specimens in a humidity chamber for one month at 95% or larger relative humidity and 28° c.
(8) Rated wood specimens with a rating from “0” (No Growth) to “5” (Complete Growth).

The effectiveness of sapstain and mildew resistance on all three examined organisms is presented in Table 7. In order to show more directly the possible synergy in the invention, the results are presented by applying the Synergy Index (S.I.), which is analyzed using the following equation:

(FGA′/FGA)+(FGB′/FGB)=SI

Wherein:

FGA=Cumulative fungal growth scores of all three examined organisms of compound A, acting alone

FGA′=Cumulative fungal growth scores of all three examined organisms of compound A, in the mixture

FGB=Cumulative fungal growth scores of all three examined organisms of compound A, acting alone

FGB′=Cumulative fungal growth scores of all three examined organisms of compound A, in the mixture

When SI is greater than 1, antagonism is indicated. When SI is less than 1, synergy is demonstrated. When SI equals to 1, the action of biocides is additive.

TABLE 7
ASTM D4445-10 test result averages. [Cumulative fungal
growth scores (0 to 5) from each set of fungi averaged over all ten (10)
replicates are presented, as well as a fractional score normalized to the
water-only control.]

| | | | | | % of | |
|---|---|---|---|---|---|---|
| | Average Scoring | | | | Water- | |
| | | | A.n. + | Σ Fungal | Only | Synergy |
| Treatment Solution | T.p. | A.p. | P.f. | Growth | Control | Index |
| IPBC + DPAB-2400 | 2.8 | 0 | 0 | 2.8 | 21.54 | 0.72 |
| ppm (20:1) | | | | | | |
| IPBC + DPAB-2400 | 1.7 | 0 | 0 | 1.7 | 13.08 | 0.43 |
| ppm (10:1) | | | | | | |
| IPBC + DPAB-2400 | 1.9 | 0 | 0 | 1.9 | 14.62 | 0.46 |
| ppm (5:1) | | | | | | |
| IPBC + DPAB-2400 | 1.3 | 0 | 0 | 1.3 | 10.00 | 0.20 |
| ppm (1:5) | | | | | | |
| IPBC + DPAB-2400 | 1.6 | 0 | 0 | 1.6 | 12.31 | 0.23 |
| ppm (1:10) | | | | | | |
| IPBC + DPAB-2400 | 1.1 | 0 | 0 | 1.1 | 8.46 | 0.15 |
| ppm (1:20) | | | | | | |
| IPBC-2400 ppm | 1.7 | 0 | 2.1 | 3.8 | 29.23 | — |
| DPAB-2400 ppm | 2 | 3.6 | 2 | 7.6 | 58.46 | — |
| Water | 5 | 4 | 4 | 13 | — | — |

The results in Table 7 demonstrate that at total amounts of 2400 ppm or more, ratios of IPBC:DPAB from 20:1 to 1:20 are synergistically effective against sapstain fungi and molds Trichoderma pseudokoningii (ATCC #26801), Aureobasidium pullulans (ATCC #9348), and a mixture of Aspergillus niger (ATCC #6275) and Penicillium funiculosum (ATCC #11797) growth on wood.

These Examples also clearly demonstrate that the combination of polymeric betaine (DPAB) and IPBC provided significantly and unexpectedly greater protection against the sapstain organism Aureobasidium pullulans and the mold organism Trichoderma sp. than treatments of either of the two components taken alone.

While the invention has been particularly described in terms of specific embodiments, those skilled in the art will understand in view of the present disclosure that numerous variations and modifications upon the invention are now enabled, which variations and modifications are not to be regarded as a departure from the spirit and scope of the invention. Accordingly, the invention is to be broadly construed and limited only by the scope and spirit of the following claims.

What is claimed:

1. A synergistic wood preservation composition comprising a polymeric betaine and 3-iodo-2-propynyl butyl carbamate (IPBC).

2. The composition of claim 1, wherein the polymeric betaine comprises didecyl bis(hydroxyethyl) ammonium borate (DPAB).

3. A method of controlling microorganisms that produce mold and/or sapstain on wood or wood products or wood coating solutions comprising applying to a wood or wood product or wood coating solutions an amount of the composition of claim 1 effective to control the microorganisms.

4. The composition of claim 1, further comprising an aqueous solvent, an organic solvent, or any mixture thereof.

5. The composition of claim 4, in the form of a solution or an emulsion.

6. The composition of claim 1, comprising an aqueous solution of the polymeric betaine and an organic solution of the IPBC.

7. The composition of claim 1, comprising about 1 to about 100 parts by weight of the polymeric betaine per about 1 to about 10 parts by weight of the IPBC.

8. The composition of claim 7, comprising about 5 to about 10 parts by weight of the polymeric betaine per about 1 part by weight of the IPBC.

9. The composition of claim 7, comprising about 1 to about 20 parts by weight of the polymeric betaine per about 20 to about 1 parts by weight of the IPBC.

10. The composition of claim 4, comprising about 15 to about 80 weight percent of the solvent or mixture of solvents.

11. The composition of claim 4, wherein the solvent or solvents are selected from the group consisting of water, aromatic solvents, polar solvents, and aliphatic solvents.

12. The composition of claim 11, wherein the solvent is selected from the group consisting of water, ethanol, ethylene glycol, propanol, propylene glycol, dimethylsulfoxide, naptha, 1,2,4, trimethyl benzene, alkyl ethers, 1,3,5 trimethyl benzene, methylethyl benzene, and mixtures thereof.

13. The composition of claim 4, comprising about 91.5 to about 99.9 weight percent of the solvent or mixture of solvents.

14. The method of claim 3, wherein the composition is applied to the wood or wood product by one or more of immersion, brush, spray, flooding, or pressure.

15. The method of claim 3, wherein the microorganisms are selected from the group consisting of Trichoderma pseudokoningii (ATCC #26801), Aureobasidium pullulans (ATCC #9348), of Aspergillus niger (ATCC #6275), Penicillium funiculosum (ATCC #11797), and mixtures thereof.
